(19) United States
(12) Patent Application Publication
(10) Pub. No.: US 2014/0238315 A1
(43) Pub. Date: Aug. 28, 2014

(54) PET FECES COLLECTION DEVICE

(71) Applicant: SHU-KUANG LEE, Taichung City (TW)

(72) Inventor: SHU-KUANG LEE, Taichung City (TW)

(21) Appl. No.: 13/775,232

(22) Filed: Feb. 24, 2013

(51) Int. Cl. A01K 23/00

(52) U.S. Cl. CPC A01K 23/00
USPC 119/868

(57) ABSTRACT

A pet feces collection device includes a plate having a through hole. Two ends of a strip are connected to the two top wings of the plate. An adjustment unit is movably connected to the strip. A left-leg belt and a right-leg belt are connected to the lower portion of the plate. An extension portion extends from the periphery of the through hole. Multiple clip portions are formed around the through hole. A bag is accommodated within the through hole and the extension portion. The periphery of the opening of the bag is secured by the clip portions. The strip is mounted to the pet, the left-leg belt and the right-leg belt extend between the two rear legs of the pet and are connected to the strip. The plate is positioned at the bottom of the pet and the anus of the pet is located at the through hole.

### FIELD OF THE INVENTION

The present invention relates to a collection device, and more particularly, to a pet feces collection device.

### BACKGROUND OF THE INVENTION

The conventional pet feces collection device is disclosed in Taiwan utility Model No. M427004 and generally comprises a frame with a notch. A recess is defined in the frame and two holes defined through the inner face of the recess. A support portion extends from the frame and communicates with the notch. A strip has one end wrapped in the recess and extends through the two holes. The other end of the strip extends beyond the frame. A first adjustment member and a second adjustment member are connected between the two ends of the strip, wherein the second adjustment member has a snap button. A first cable and a second cable both are a loop-like cable and are connected to the frame.

However, when using the device, the tail of the pet such as a dog is not located in the notch and the strip foes beyond the tail and is connected to the snap button on the second cable. The are two connection points on the pets back and waist, in other words, the first and second adjustment members are located on a straight line, such that when the dog tail swings, the frame is easily loosened.

The bag has to be mounted to the frame by its opening and the portion defining the opening is pulled through the gap between the recess and the strap to a certain distance to let the strip be located outside of the opening of the bag. The first adjustment member is then pulled to tie the opening of the bag to the recess of the frame. The first cable goes through the second cable, and the first or second cable is hooked to the snap button. Finally, the second adjustment member is moved to set the final position. The steps are complicated and inconvenient.

Some dogs such as the German Shepherds, Peruvian Inca Orchids, Sloughis, Whippet and Italian Greyhounds, their tails normally extend downward and the position of anus is located lower, so that the conventional feces collection device tends to slip downward because the first and second adjustment members are located on a straight line.

The present invention intends to provide a pet feces collection device that improves the shortcomings of the conventional pet feces collection device.

### SUMMARY OF THE INVENTION

The present invention relates to a pet feces collection device and comprises a plate having a through hole. A first recess is defined in the top edge of the plate and the tail of a pet extends through the first recess. The plate has two top wings and the first recess is located between the two top wings. Each of the two top wings has a positioning portion. A strip has two ends respectively connected to the two respective positioning portions of the two top wings. The middle portion of the strip extends through an adjustment unit to form an enclosed mounting portion and two restriction sections. The adjustment unit is located between the mounting portion and the two restriction sections which are connected to the plate. A mounting area is defined by the mounting portion and a restriction area is defined between the adjustment unit, the two restriction sections and the two top wings of the plate. A left-leg belt and a right-leg belt are connected to two corners of the lower portion of the plate. Each of the left-leg belt and the right-leg belt has a connection member connected thereto which is connected to the mounting portion of the strip. The mounting portion is mounted to the pet and the plate is located at the bottom of the pet. The tail extends through the restriction area. The two respective connection members of the left-leg belt and the right-leg belt extend between two rear legs of the pet and are connected to the mounting portions. The through hole of the plate is aligned with anus of the pet.

Multiple clip portions are formed around the through hole. A bag is accommodated within the through hole and the extension portion. The periphery of the opening of the bag is secured by the clip portions. The feces is directly collected in the bag.

The primary object of the present invention is to provide a pet feces collection device which is cable to be used to any type of dogs and the device is not loosened.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pet feces collection device of the present invention;

FIG. 2 is a perspective view to show the pet feces collection device of the present invention;

FIG. 3 is a cross sectional view taken along the line A-A in FIG. 2;

FIG. 4 is a cross sectional view taken along the line B-B in FIG. 2;

FIG. 5 shows the use status of the pet feces collection device of the present invention, and

FIG. 6 is an exploded view to show another embodiment of the pet feces collection device of the present invention.

### DETAILED DESCRIPTION OF THE PREFERRED EMBODIMENT

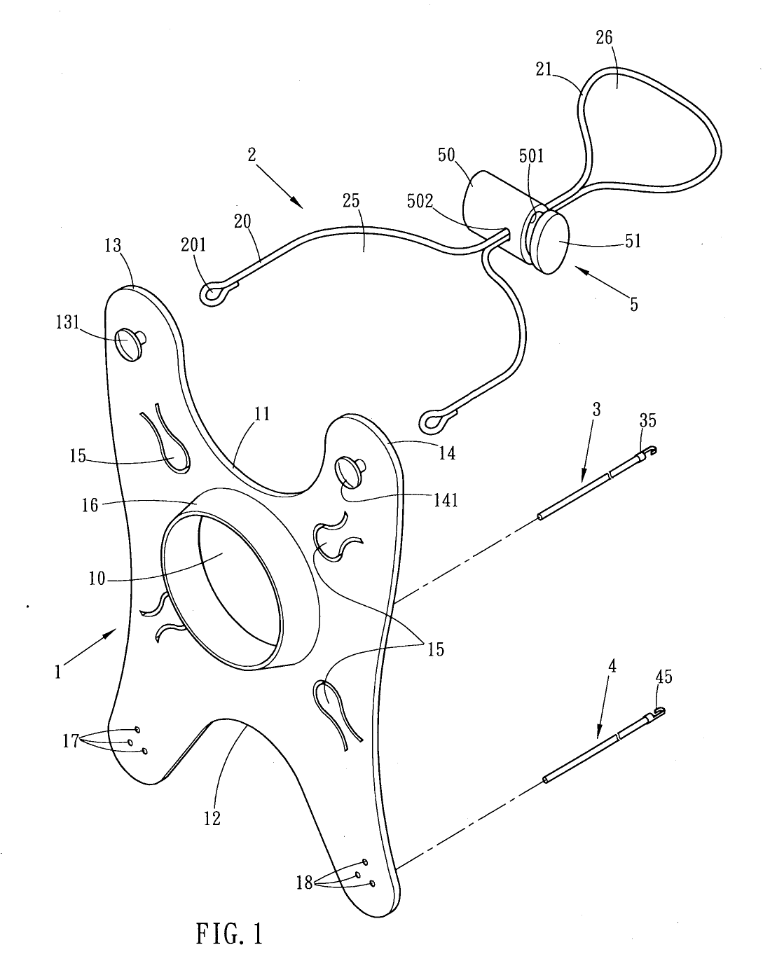

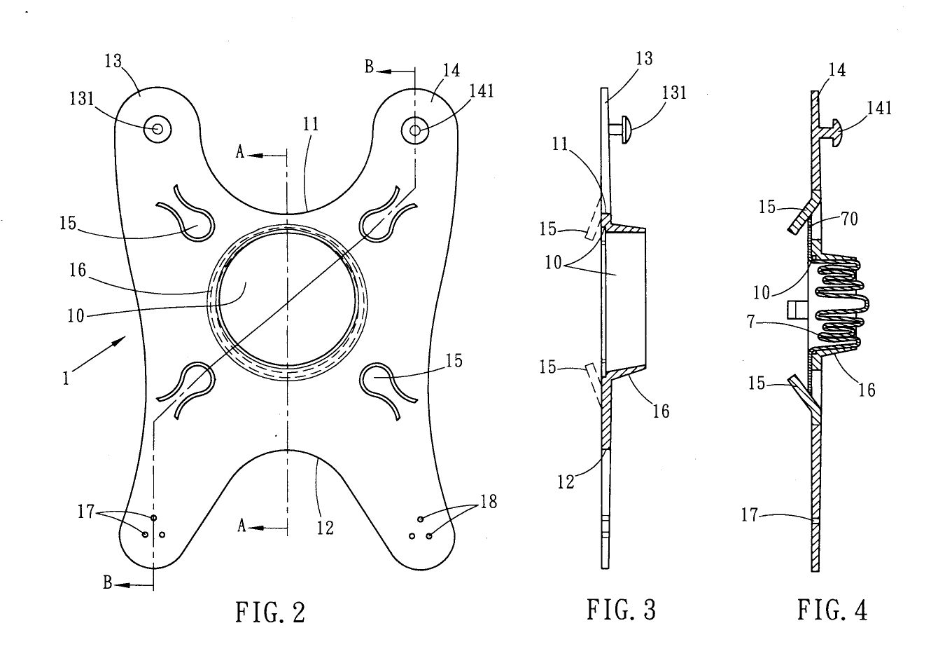

Referring to FIGS. 1 to 6, the pet feces collection device of the present invention comprises a plate 1 having a through hole 10. A first recess 11 is defined in the top edge of the plate 1 and sized so that the tail 60 of a pet 6 may extend therethrough. The through hole 10 does not communicate with the first recess 11. A second recess 12 is defined in the bottom edge of the plate 1 and sized to yield to the genital 63 of the pet 6. The plate 1 has two top wings 13, 14 and the first recess 11 is located between the two top wings 13, 14. Each of the two top wings 13, 14 has a positioning portion 131/141 which can be a protrusion, a protrusion with an enlarged head, or a slot. The thickness of the two top wings 13, 14 are thinner than the thickness around the through hole 10. A tubular extension portion 16 extends from the periphery of the through hole 10 and multiple clip portions 15 are formed and around the through hole 10. The periphery 70 of the opening of a bag 7 is inserted into the slots of the clip portions 15 and securely positioned by the clip portions 15, and the bag 7 is accommodate within the through hole 10 and the extension portion 16. The two corners of the lower portion of the plate 1 each have three apertures 17/18 defined therethrough.

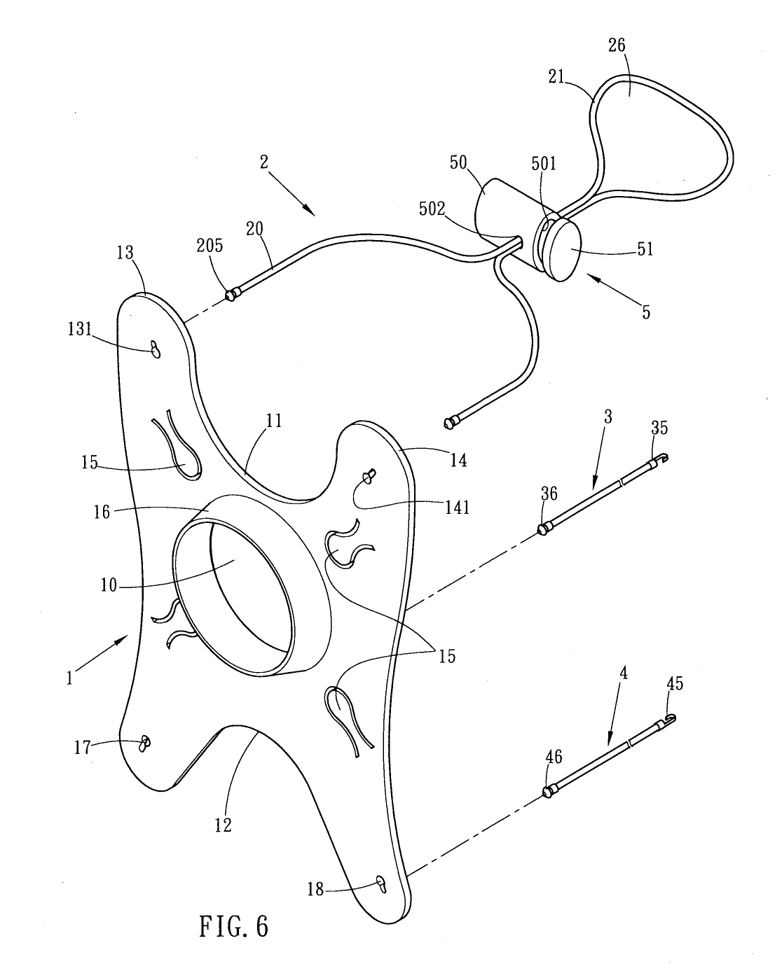

A strip 2 has two ends which are respectively connected to the two respective positioning portions 131, 141 of the two top wings 13, 14 directly or indirectly. The strip 2 can be made by resilient band, belt, rope or wire. The middle portion of the strip 2 extends through an adjustment unit 5 to form an enclosed mounting portion 21 and two restriction sections 20, wherein the adjustment unit 5 is located between the mounting portion 21 and the two restriction sections 20 which are connected to the plate 1. A mounting area 26 is defined by the mounting portion 21. A restriction area 25 being defined between the adjustment unit 5, the two restriction sections 20 and the two top wings 13, 14 of the plate 1. By moving the adjustment unit 5, the size and length of the mounting portion 21 and the two restriction sections 20 can be adjusted. By the adjustment, the two top wings 13 are adjusted to snugly connect the root portion of the tail 60. In other words, the sizes of the restriction area 25 and the mounting area 26 can be adjusted by moving the adjustment unit 5. The two ends of the strip 2 each have a loop 201 formed thereto and the two respective loops 201 are connected to the two positioning portions 131, 141. Alternatively, as shown in FIG. 6, the two ends of the strip 2 each have a positioning member 205 connected thereto and the two respective positioning members 205 are connected to the two positioning portions 131, 141 which are slots. The positioning members 205 can be hooks, resilient hooks or protrusions with an enlarged head.

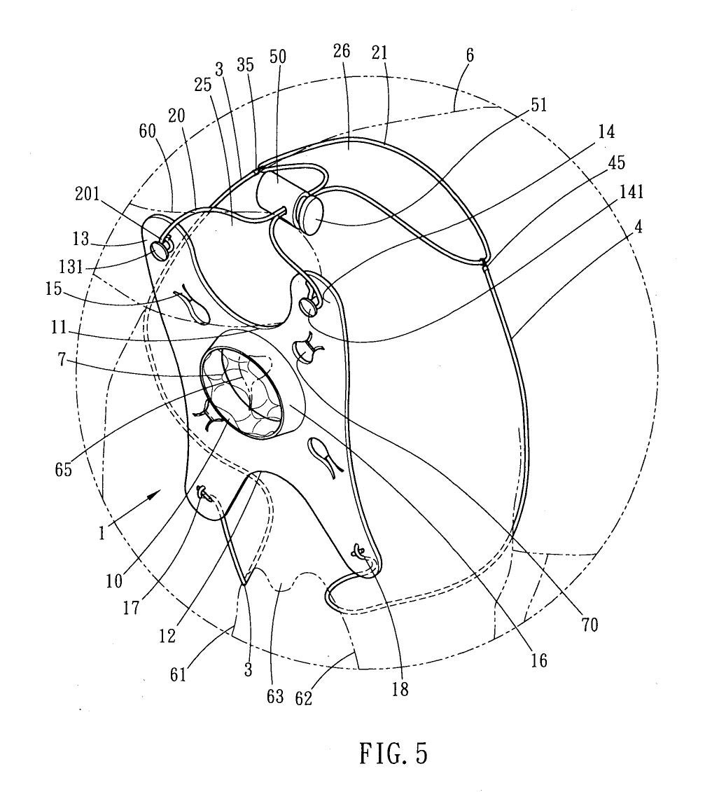

A left-leg belt 3 and a right-leg belt 4 are connected to the apertures 17, 18 of the two corners of the lower portion of the plate 1 directly or indirectly. The left-leg belt 3 and the right-leg belt 4 can be made by resilient bands, belts, ropes or wires. Alternatively, each of the left-leg belt 3 and the right-leg belt 4 has a positioning member 36/46 connected thereto which are secured to the apertures 17. 18. As shown in FIG. 6, the positioning members 36, 46 each have an enlarged head which are positioned with the apertures 17. 18 which are two slots each are composed a small hole and a large hole. The positioning members 35, 45 can be hooks, resilient hooks or protrusions with an enlarged head. The other end of each of left-leg belt 3 and the right-leg belt 4 has a connection member 35/45. The two respective connection members 35, 45 of the left-leg belt 3 and the right-leg belt 4 extend between two rear legs 61, 62 of the pet 6 and are connected to the mounting portions 21. Therefore, the mounting area 26 is pulled to be a triangular area as shown in FIG. 5 to be secured.

The adjustment unit 5 comprises a body 50 with a room 501 defined therein and a movable member 51 is inserted into the room 501 and biased by a spring (not shown) in the room 501. The body 50 has a passage 502 and the movable member 51 has another passage (not shown), the adjustment unit 5 is movable along the strip 2 when the passage 502 of the body 50 and passage of the movable member 51 are in alignment with each other.

When in use, the loops 201 are connected to the positioning portions 131, 141 on the plate 1. The left-leg belt 3 and the right-leg belt 4 are respectively connected to the apertures 17. 18. The two respective connection members 35, 45 of the left-leg belt 3 and the right-leg belt 4 extend between two rear legs 61, 62 of the pet 6 and are connected to the mounting portions 21.

The periphery 70 of the opening of a bag 7 is inserted into the slots of the clip portions 15 and securely positioned by the clip portions 15, and the bag 7 is accommodate within the through hole 10 and the extension portion 16 as shown in FIG. 4. The bag 7 does not hang outside the plate 1 and is not dragged by objects when the pet 6 moves. The restriction area 25 is located at the root portion of the tail 60 and the adjustment unit 5 is moved toward the plate 1 until the restriction area 25 becomes smaller and the two top wings 13, 14 snugly contact the bottom of the pet 6. The two respective connection members 35, 45 of the left-leg belt 3 and the right-leg belt 4 extend between two rear legs 61, 62 of the pet 6 and are connected to the mounting portions 21. Therefore, the mounting area 26 is pulled to be a triangular area as shown in FIG. 5 and the strip 2 is secured. The through hole 10 of the plate 1 is aligned with anus 65 of the pet 6.

The use of the present invention is easy and convenient, and can be used for any dogs regardless the position of the anus 65. The feces 68 are directly collected in the bag 7 which can then be removed from the plate 1 and discarded.

While we have shown and described the embodiment in accordance with the present invention, it should be clear to those skilled in the art that further embodiments may be made without departing from the scope of the present invention.

What is claimed is:

1. A pet feces collection device comprising:
a plate having a through hole, a first recess defined in a top edge of the plate and adapted to yield a tail of a pet, the plate having two top wings and the first recess located between the two top wings, each of the two top wings having a positioning portion;
a strip having two ends which are respectively connected to the two respective positioning portions of the two top wings, a middle portion of the strip extending through an adjustment unit to form an enclosed mounting portion and two restriction sections, the adjustment unit located between the mounting portion and the two restriction sections which are connected to the plate, a mounting area defined by the mounting portion, a restriction area being defined between the adjustment unit, the two restriction sections and the two top wings of the plate;
a left-leg belt and a right-leg belt connected to two corners of a lower portion of the plate, each of the left-leg belt and the right-leg belt having a connection member connected thereto which is connected to the mounting portion of the strip, the mounting portion adapted to be mounted to the pet and the plate adapted to be located at the bottom of the pet, the tail extending through the restriction area, the two respective connection members of the left-leg belt and the right-leg belt adapted to extend between two rear legs of the pet and be connected to the mounting portions, the through hole of the plate adapted to be aligned with anus of the pet.

2. The device as claimed in claim 1, wherein the two corners of the lower portion of the plate each have apertures and the left-leg belt and the right-leg belt are secured to the apertures.

3. The device as claimed in claim 2, wherein the plate has multiple clip portions located around the through hole so as to secure a periphery of an opening of a bag.

4. The device as claimed in claim 3, wherein the strip has two respective positioning members respectively connected to the two ends thereof.

5. The device as claimed in claim 4, wherein each of the left-leg belt and the right-leg belt has a positioning member connected thereto which are secured to the apertures.

6. The device as claimed in claim 5, wherein the plate has an extension portion extending from a periphery of the through hole and the bag is accommodate within the through hole and the extension portion.

7. The device as claimed in claim 6, wherein the positioning portions are protrusions or slots, the positioning members are insertions with an enlarged head.

8. The device as claimed in claim 3, wherein the two ends of the strip each have a loop formed thereto and the two respective loops are connected to the two positioning portions.

9. The device as claimed in claim 8, wherein each of the left-leg belt and the right-leg belt has a positioning member connected thereto which are secured to the apertures.

10. The device as claimed in claim 9, wherein the plate has an extension portion extending from a periphery of the through hole and the bag is accommodate within the through hole and the extension portion.

11. The device as claimed in claim 10, wherein the positioning portions are protrusions or slots, the positioning members are insertions with an enlarged head.
